(19) United States
(12) Patent Application Publication
(10) Pub. No.: US 2026/0006584 A1
(43) Pub. Date: Jan. 1, 2026

(54) DEVICES, METHODS AND SYSTEM FOR HANDLING EVENTS IN MOBILE COMMUNICATIONS NETWORKS

(71) Applicant: HUAWEI TECHNOLOGIES CO., LTD., Shenzhen (CN)

(72) Inventors: Sripriya Srikant Adhatarao, Munich (DE); Qing Wei, Munich (DE); Osama Abboud, Munich (DE)

(73) Assignee: HUAWEI TECHNOLOGIES CO., LTD., Shenzhen (CN)

(21) Appl. No.: 19/322,936

(22) Filed: Sep. 9, 2025

Related U.S. Application Data
(63) Continuation of application No. PCT/EP2023/056112, filed on Mar. 10, 2023.

(51) Int. Cl. H04W 68/02; G06F 9/54

(52) U.S. Cl. CPC H04W 68/02; G06F 9/542

(57) ABSTRACT

Related to telecommunications, a method and system include a control-plane (CP) entity and a user-plane (UP) entity. The CP entity is configured to generate a first list and a second list, and send the first list and the second list to the UP entity. The first list indicates a plurality of network events and a plurality of corresponding actions that the UP entity is allowed to perform. The second list indicates a plurality of network functions for notifying the UP entity of the plurality of network events. The UP entity is configured to send one or more subscription requests for subscribing to one or more of the plurality of network events based on the first list and the second list. When receiving a network event trigger, the UP entity may be configured to take a corresponding action in accordance with the first list.

### CROSS-REFERENCE TO RELATED APPLICATIONS

This application is a continuation of International Application No. PCT/EP2023/056112, filed on Mar. 10, 2023, which is hereby incorporated by reference in its entirety.

### TECHNICAL FIELD

The embodiments generally relate to the field of communications technology, and include devices, methods, and a system for handling network events in mobile communications networks.

### BACKGROUND

The 3rd Generation Partnership Project (3GPP) standards release 15-18 introduced Service Based Architecture (SBA) for the fifth generation (5G) mobile communications systems supporting three main types of communication services: enhanced Mobile BroadBand (eMBB), ultra Reliable Low Latency Communications (uRLLC), and massive Machine Type Communications (mMTC). Standardized Network Functions (NF) with Service Based Interface (SBI) for message exchange between the NFs is defined. In the sixth generation (6G) mobile communications systems, more advanced embodiments and services are proposed to be supported, such as holographic telepresence, immersive experience, digital twins, etc. Advancements in technology enable 6G where, billions of sophisticated and complex mobile devices are connected with stringent performance requirements from communication networks. Moreover, embodiments and services like autonomous driving, tactile Internet, eXtreme Reality (XR), Internet of Things (IoT), holographic communications, etc., may produce, collect, and process massive amounts of data and require extremely low latency to operate and control devices like sensors and actuators in addition to facilitating real-time device-to-device communications.

The aforementioned use cases, bring many new and strict requirements like faster signal processing, higher data rates, ultra-low latency, increased security, privacy, and reliability from the underlying communication networks to provide a smooth end-to-end (e2e) experience for users. Such extreme requirements raise the need for high data rate, low latency and high-capacity communications networks that provide extreme coverage and performance guarantees.

3GPP 5G networks provide a Protocol Data Unit (PDU) connectivity service that allows a User Equipment (UE) to exchange PDUs with a Data Network (DN). To this end, the UE requests to establish a PDU session in order to enable the desired packet exchange with the DN. A Control Plane (CP) entity named Session Management Function (SMF) is responsible for verifying UE subscription information and approving the session establishment request. When the SMF receives the session establishment request, it retrieves UE subscription data from Unified Data Management (UDM) along with Quality of Service (QOS) and policy data from Policy Control Function (PCF) and verifies the UE session establishment request for compliance. Once approved, SMF generates the Packet Detection Rules (PDR), Forwarding Action Rules (FAR), Quality of Service Enforcement Rules (QER), Usage Reporting Rules (URR), Buffering Action Rules (BAR), and PFCP session context for the PDU session. A User Plane Function (UPF) (as an example of user plane (UP) NF), is used to handle all user traffic in the mobile network. Hence, once the PDU session rules are generated, the SMF selects a UPF and passes the PDU session rules and configurations to add/update/delete rules via a designated N4 interface. When the UPF receives a PDU belonging to a configured session from a Next Generation Radio Access Network (NG-RAN), it processes the packet by applying the pre-configured rules from the SMF and forwards it to the DN based on the FAR

A 3GPP 5G SBA enriches NFs to provide services like Event Exposure to interested CP NFs. Any CP NF can request/subscribe to receive information/notification from the NFs that produce the information of interest. When a CP NF like the SMF receives a request for information via SBI, the response is sent back almost immediately with the requested information. Whereas, for subscriptions, a subscribing NF sends a subscription request to a notifying NF like Network Data Analytics Function (NWDAF) that may notify the subscribing NF of any information of interest. Upon receiving a subscription request, the notifying NF adds the subscribing NF to its list of subscribers and publishes the notifications to all subscribed NFs, when any event of their interest occurs. Similar to CP NFs, UPF also provides a “Nupf_EventExposure” service using which it exposes UP-related information to interested CP NFs e.g., events on the PDU session.

### SUMMARY

According to a conventional solution, uRLLC may be supported by providing redundant transmissions in the UP for uRLLC sessions. In order to support the uRLLC sessions, a UE can initiate dual connectivity with two redundant PDU sessions, or utilize redundancy supported at the transport layer, or send packets over two N3 and N9 tunnels between the NG-RAN and PDUSession Anchor (PSA) UPF. With dual connectivity, the mobile network sets up two independent PDU sessions to ensure higher reliability with different combinations of DN and Single-Network Slice Selection Assistance Information (S-NSSAI). Whereas with transport layer supported uRLLC, the SMF selects a UPF capable of redundant transmission. That is, the UPF is capable of duplicating DL packets on the transport layer and forwarding it to the NG-RAN which then eliminates the duplicate packets before forwarding it to the UE. NG-RAN duplicates the UL packets and forwards them to the UPF which then eliminates the duplicate packet and forwards it to the designated DN. While with dual N3 and N9 tunnels, the SMF configures different routing information in the tunnels which are mapped to disjoint transport layer paths. During the dual tunnel configurations, when UPF receives DL packets, PSA UPF replicates the packets and assigns the same GTP-U sequence number to facilitate redundant transmission. NG-RAN eliminates the duplicate packet before forwarding it to UE. For UL packets, NG-RAN replicates the packet and assigns the same GTP-U sequence number, and forwards it to UPF separately via the two N3 tunnels. The UPF eliminates the duplicate packet before forwarding it to the designated DN.

Some CP NFs like NWDAF and Application Function (AF) are also interested in the information produced in UP NFs. However, due to CP-UP separation architectural principle in 5G (and beyond), a UPF can have access to SMF and limited access to other CP NFs to provide simple event exposure. Nonetheless, the UPF cannot subscribe to the events exposed by any CP NFs.

In current mobile networks, uRLLC can be supported based on redundant transmission. However, in 5G and 6G, billions of devices are expected to be connected to the mobile network and hence, redundant transmissions cannot scale well in the presence of billions of connections with strict performance requirements.

CP NFs hold autonomy in making decisions when an event (e.g., a network-related event) occurs; while UP NFs wait to receive and enforce these decisions. However, the decision making is not in run-time. Moreover, any changes to the ongoing PDU session involves decision making among a series of CP NFs (e.g., a long path in decision-making: UPF—SMF—PCF—AF—PCF—SMF—UPF) which not only increases signaling traffic but also results in increased latency in responding to any event in the UP. This inadvertently hinders any dynamic or urgent reactions from the UP during changing network behavior like changing channel conditions, fluctuations in user density, congestion, etc.

Currently, the SMF is allowed to handle subscriptions from CP NFs to UPF, However, UPF does not have access to any services which can identify events that can occur in the UP. The CP NFs identify UP events or receive event notifications from NFs that produce such information and then invoke a series of NFs to arrive at the decision on how to handle the identified event. Since the CP NFs responsible for decision-making for the user plane are reactive, they introduce delay in the user plane's response to events and thereby affect the uRLLC and QoS requirement expected by many 5G and 6G embodiments.

For many embodiments like autonomous driving, holographic communications, etc., timely arrival of packets and reliable packet delivery are crucial to synchronize data collected from multiple sources and make decisions in real-time. Therefore, faster and more reliable delivery of packets between end-users or between end-user and a service provider may be required regardless of any changing network behavior. This is more stringent for some embodiments, since latency from the mobile network may have adverse effects such as collision, injury, etc.

Currently, if an SMF fails or goes down or if a UPF loses connection with the SMF, the PDU sessions are abandoned until a new SMF takes over. Then, the PDU session is restarted in the same/new UPF. This may impact reliability, which is crucial for uRLLC embodiments.

In summary, current UP NF is not able to leverage CP decisions and events notifications for dynamic/real-time adaptation of the traffic characteristics and/or network environment.

In view of the above-mentioned problems and disadvantages, the embodiments aim to enhance UP and CP NFs for mobile communications systems such that the delay in response to various events in the network can be improved. An objective may be to enable dynamic and real-time response in handling events at UP NFs.

A first aspect of the embodiments provides a CP entity for a telecommunications network. The CP entity is configured to generate a first list indicating a plurality of events and a plurality of corresponding actions that a UP entity is allowed to perform, and generate a second list indicating a plurality of NF entities for notifying the UP entity of the plurality of events. The CP entity is further configured to send the first list and the second list to the UP entity.

It is noted that the first list is indicative of (or includes information on) the plurality of events and the plurality of corresponding actions. The second list is indicative of (or includes information on) the plurality of NF entities for notifying the UP entity of the plurality of events. In the embodiments, the CP entity may be referred to as a CP NF, the UP entity may be referred to as a UP NF, and a general NF entity may be simply referred to as a NF. The event may be any event that could happen in the network. For instance, the event may be related to the network, user behavior, or embodiments/services. In the embodiments, the event may be referred to as a “network event”. Optionally, the event may be identified by a corresponding event ID.

Optionally, the first list and the second list may be combined into a hybrid list. For sending the first list and the second list, the CP entity may be configured to send the hybrid list to the UP entity.

Optionally, the plurality of NF entities for notifying the UP entity of the plurality of events may be simply referred to as “notification NF entities”. The CP entity may be one of the notification NF entities.

Optionally, the CP entity may be an SMF, and the UP entity may be a UPF.

By pre-configuring the plurality of events and the plurality of corresponding actions by the CP NF in the UP NF, event processing in the user plane can become more efficient as the user plane can become autonomous by performing dynamic and real-time actions to address events in the network in accordance with the first list. Thereby, the QoS delivered to end users can be improved.

In an embodiment form of the first aspect, each action may include one or more instructions to be performed by the UP entity for a corresponding event in the network.

For instance, the one or more instructions may include one or more PDU session rules (e.g., FAR, QER, BAR rules).

In a further embodiment form of the first aspect, the CP entity may be configured to generate the first list and the second list by:
determining the plurality of events that the UP entity is allowed to be notified of based on network configuration information;
generating the plurality of corresponding actions that the UP entity is allowed to perform for the determined plurality of events; and
obtaining the list of NF entities for notifying the UP entity based on the determined plurality of events

Optionally, the network configuration information may include UE subscription information and/or policy information.

In a further embodiment form of the first aspect, the CP entity may be configured to send the first list and the second list to the UP entity via a dedicated interface, optionally via an N4 interface.

In a further embodiment form of the first aspect, the CP entity may be configured to:
receive one or more subscription requests from the UP entity for subscribing to one or more of the plurality of events; and
send the one or more subscription requests to the one or more respective NF entities.

In a further embodiment form of the first aspect, before sending the one or more subscription requests, the CP entity may be configured to add and/or modify one or more parameters in the received one or more subscription requests.

In a further embodiment form of the first aspect, the CP entity may be configured to send the first list and the second list to the UP entity during a lifetime of a session (e.g., a PDU session), during a lifetime of a service delivery, or during a lifetime of the UP entity.

A second aspect of the embodiments provides a UP entity for a telecommunications network. The UP entity is configured to receive, from a CP entity, a first list indicating a plurality of events and a plurality of corresponding actions that the UP entity is allowed to perform, and a second list indicating a plurality of NF entities for notifying the UP entity of the plurality of events. The UP entity is further configured to send one or more subscription requests for subscribing to one or more of the plurality of events based on the first list and/or the second list.

In this way, based on the first list and the second list, the UP entity can become autonomous in performing dynamic and real-time actions to address events in accordance with the first list and/or the second list. Further, processing delay can be reduced when the event occurs, since a long decision-making process at the control plane can be avoided. Therefore, the QoS of end users can be improved.

Optionally, the UP entity may be configured to receive a hybrid list from the CP entity. The hybrid list may include the first list and the second list.

Optionally, the CP entity may be an SMF, and the UP entity may be a UPF.

Optionally, the one or more subscription requests may be sent through a dedicated interface, such as a Nupf SBI interface.

In this way, the Nupf SBI can be enhanced to not only provide user plane-related information to the control plane, but also to subscribe and receive event notifications from the control plane in the user plane. In this way, the signalling traffic and latency can be reduced between the control plane and the user plane when responding to events.

In an embodiment form of the second aspect, the UP entity may be configured to send a respective subscription request to the CP entity.

In a further embodiment form of the second aspect, the UP entity may be configured to send a respective subscription request to a respective NF entity based on the second list.

In a further embodiment form of the second aspect, the UP entity may be further configured to be notified, by a respective NF entity or by the CP entity, of a triggered event.

In a further embodiment form of the second aspect, the UP entity may be further configured to:
determine whether the triggered event is on the first list and/or whether the triggered event is originated from a corresponding NF entity on the second list; and
in response to determining that the triggered event is on the first list and/or the trigger event is originated from the corresponding NF on the second list, perform a corresponding action in accordance with the first list.

A third aspect of the embodiments provides a system. The system includes one or more CP entities according to the first aspect or any embodiment forms thereof, and one or more UP entities according to the second aspect or any embodiment forms thereof.

The system may further include one or more notification NF entities. The one or more UP entities may send one or more subscription requests to the one or more CP entities and/or one or more notification NF entities for subscribing to one or more of the plurality of events based on the first list and/or the second list.

That is, a certain UP entity may send a subscription request to a certain CP entity for subscribing to a certain event. This may happen when case I: the certain CP entity is one of the plurality of notification NF entities for notifying the UP entity of the certain event, or when case II: the UP entity has no interface or permission or access to all the information required in the subscription request to communicate directly with a corresponding notification NF entity for notifying the UP entity of the certain event. In case II, the certain CP entity may forward the subscription request to the corresponding notification NF entity (on behalf of the certain UP entity). Before forwarding the subscription request, the CP entity may be configured to modify the subscription request (e.g., add any missing information in the subscription request).

Additionally or alternatively, the certain UP entity may send a (further) subscription request to a corresponding notification NF entity for subscribing to a corresponding event. This may happen when the certain UP entity has an interface to communicate with the corresponding notification NF entity.

A fourth aspect of the embodiments provides a method for a telecommunications network. The method includes the following steps or operations:
generating, by a CP entity, a first list indicating a plurality of events and a plurality of corresponding actions that a user-plane, UP, entity is allowed to perform;
generating, by the CP entity, a second list indicating a plurality of network function, NF, entities for notifying the UP entity of the plurality of events; and
sending, by the CP entity, the first list and the second list to the UP entity.

In an embodiment form of the fourth aspect, each action may include one or more instructions to be performed by the UP entity for a corresponding event.

In a further embodiment form of the fourth aspect, the steps or operations of generating the first list and the second list may include:
determining the plurality of events that the UP entity is allowed to be notified of based on network configuration information;
generating the plurality of corresponding actions that the UP entity is allowed to perform for the determined plurality of events; and
obtaining the list of NF entities for notifying the UP entity based on the determined plurality of events.

In a further embodiment form of the fourth aspect, the first list and the second list may be sent by the CP entity to the UP entity via a dedicated interface, optionally via an N4 interface.

In a further embodiment form of the fourth aspect, the method may further include:
receiving, by the CP entity, one or more subscription requests from the UP entity for subscribing to one or more of the plurality of events; and
sending, by the CP entity, the one or more subscription requests to the one or more respective NF entities.

In a further embodiment form of the fourth aspect, before sending the one or more subscription requests, the method may further include adding and/or modifying, by the CP entity (as an authorized entity), one or more parameters in the received one or more subscription requests.

In a further embodiment form of the fourth aspect, the first list and the second list may be sent by the CP entity to the UP entity during a lifetime of a session (e.g., a PDU session), during a lifetime of a service delivery, or during a lifetime of the UP entity.

The method of the fourth aspect may share the same features and advantages as the CP entity of the first aspect.

A fifth aspect of the embodiments provides a method for a telecommunications network. The method includes the following steps or operations:
receiving, by a UP entity from a CP entity, a first list indicating a plurality of events and a plurality of corresponding actions that the UP entity is allowed to perform;
receiving, by the UP entity from the CP entity, a second list indicating a plurality of NF entities for notifying the UP entity of the plurality of events; and
sending, by the UP entity, one or more subscription requests for subscribing to one or more of the plurality of events based on the first list and/or the second list.

In an embodiment form of the fifth aspect, a respective subscription request may be sent by the UP entity to the CP entity.

In a further embodiment form of the fifth aspect, a respective subscription request may be sent by the UP entity to a respective NF entity based on the second list.

In a further embodiment form of the fifth aspect, the method may further include receiving, by the UP entity, a notification from a respective NF entity or the CP entity of a triggered event.

In a further embodiment form of the fifth aspect, the method may further include determining, by the UP entity, whether the triggered event is on the first list and/or whether the triggered event is originated from a corresponding NF entity on the second list. In response to determining that the triggered event is on the first list and/or the trigger event is originated from the corresponding NF on the second list, the method may further include performing, by the UP entity, a corresponding action in accordance with the first list.

The method of the fifth aspect may share the same features and advantages as the UP entity of the second aspect.

A sixth aspect of the embodiments provides a computer program comprising a program code for performing the method according to the fourth aspect or any of its embodiment forms.

A seventh aspect of the embodiments provides a computer program comprising a program code for performing the method according to the fifth aspect or any of its embodiment forms.

An eighth aspect of the embodiments provides a non-transitory storage medium storing executable program code which, when executed by a processor, causes the method according to the fourth aspect or any of its embodiment forms to be performed.

A ninth aspect of the embodiments provides a non-transitory storage medium storing executable program code which, when executed by a processor, causes the method according to the fifth aspect or any of its embodiment forms to be performed.

A tenth aspect of the embodiments provides a chipset storing executable program code which, when executed by the chipset, causes the method according to the fourth aspect or any of its embodiment forms to be performed.

An eleventh aspect of the embodiments provides a chipset storing executable program code which, when executed by the chipset, causes the method according to the fifth aspect or any of its embodiment forms to be performed.

It has to be noted that all entities, elements, units, functions and means described in the present embodiments could be implemented in the software or hardware elements or any kind of combination thereof. All steps or operations which are performed by the various entities described in the present embodiments as well as the functionalities described to be performed by the various entities are intended to mean that the respective entity is adapted to or configured to perform the respective steps or operations and functionalities. Even if, in the following description of the embodiments, a functionality or step or operation to be performed by external entities is not reflected in the description of a detailed element of that entity which performs that step or operation or functionality, it may be understood by a skilled person that these methods and functionalities can be embodied in respective software or hardware elements, or any kind of combination thereof.

### BRIEF DESCRIPTION OF DRAWINGS

The above-described aspects and embodiment forms may be explained in the following description in relation to the enclosed drawings, in which

FIG. 1 shows an example of a correlation among network entities of a telecommunications network;

FIG. 2 shows a CP entity and a UP entity according to the embodiments;

FIG. 3 shows an exemplary signaling flow for a CP entity notifying a first list and a second list to a UP entity according to the embodiments;

FIG. 4 shows an exemplary signaling for a UP entity subscribing to network events according to the embodiments;

FIG. 5 shows an example of event processing performed by a UP entity according to the embodiments;

FIG. 6 shows an application scenario of the embodiments;

FIG. 7 shows a diagram of a method according to the embodiments; and

FIG. 8 shows a diagram of a further method according to the embodiments.

### DETAILED DESCRIPTION OF EMBODIMENTS

A list of key terms and their acronyms/abbreviations used in the embodiments is given as follows: 3rd Generation Partnership Project-3GPP; Access and Mobility management Function—AMF; Application Function—AF; Buffering Action Rules—BAR; Control Plane—CP; Data Network—DN; Edge Application Server—EAS; Forwarding Action Rules—FAR; Network Data Analytics Function—NWDAF; Network Exposure Function—NEF; Network Function—NF; Packet Detection Rules—PDR; Management Plane—MP; Packet Forwarding Control Protocol—PFCP; Policy Control Function—PCF; Protocol Data Unit—PDU; PDU Session Anchor—PSA; Quality of Service—QoS; Quality of Service Enforcement Rules—QER; Reinforcement Learning—RL; Service Based Architecture—SBA; Service Based Interface—SBI; Session Management Function—SMF; ultra-Reliable Low Latency Communications—uRLLC; Unified Data Management—UDM; Uplink Classifier—UL CL; Usage Reporting Rules—URR; User Equipment—UE; User Plane—UP.

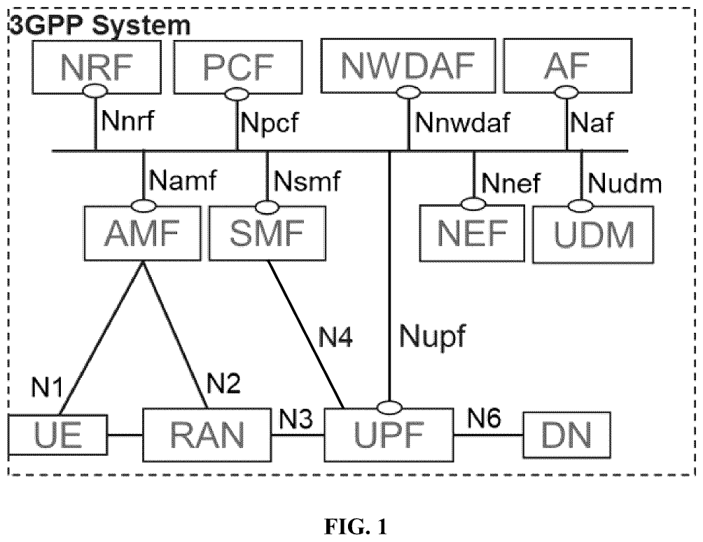

FIG. 1 shows an example of a correlation among network entities of a telecommunications network.

The telecommunications network may be a mobile communications network predetermined by 3GPP, which may be referred to as a 3GPP system. For instance, the 3GPP system may be a 5G system, a 6G system, or any next-generation system (beyond 5G). It shall be understood that the embodiments may not only be applied to a 3GPP system, but also be applied to other communications systems having a similar architecture to the 3GPP system. As illustrated in FIG. 1, the 3GPP system includes a number of NFs, such as an Access and Mobility Management Function (AMF), a Session Management Function (SMF), a Network Exposure Function (NEF), a Network Repository Function (NRF), a Policy Control Function (PCF), a Network Data Analytics Function (NWDAF), an Application Function (AF), and a Unified Data Management (UDM) function. These NFs are interconnected via dedicated interfaces that are shown in FIG. 1. Due to the separation of the control plane and user plane in the 3GPP system, there are at least two possible types of network functions: control plane network functions (CP NF), and user plane network functions (UP NF). The AMF, SMF, NEF, UDM, NRF, PCF, NWDAF are examples of CP NFs. The UPF is an example of a UP NF.

The UPF is configured to handle UE data sessions in the network. However, it is the duty of CP to make decisions when an event of interest is identified in the UP. Conventionally, a UP NF (e.g., the UPF) simply waits for decisions from the CP when an event occurs in the network. In the embodiments, a solution is proposed to provide certain autonomy to UP in responding to certain events (possibly in real-time) whose responses can be pre-configured by the CP, possibly before a UE session begins. Thereby, the embodiments allow a UP NF to be more dynamic and flexible in responding to events observed in the network. It may also prevent any delay that arises from run-time decision-making in the CP.

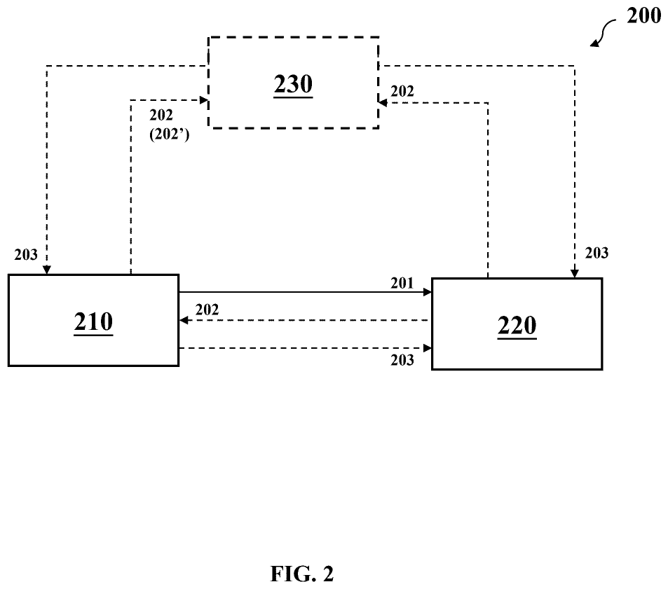

FIG. 2 shows a CP entity 210 and a UP entity 220 according to the embodiments. As an example, a further CP entity 230 is illustrated. For the sake of readability, in the embodiments, the CP entity 210 may correspond to an SMF 210, the further CP entity 230 may correspond to an NWDAF, and the UP entity 220 may correspond to a UPF 220. However, it shall be understood that the embodiments may be applied to any CP NF and UP NF where applicable. The SMF 210 and the UPF 220 may form a system 200.

The SMF 210 is configured to generate a first list. The first list is indicative of a plurality of network events and a plurality of corresponding actions that the UPF 220 is allowed to perform. For instance, the first list may include information such as {a first event, a first action; a second event, a second action; . . . }. In a possible example, a list of possible network events and a list of actions may be pre-defined, e.g., in 3GPP. The SMF 210 may be configured to determine what action the UPF is allowed to perform for an event in the network. The result of the determination can be reflected in the first list. The network events and the corresponding actions may be associated with their respective type identifications (IDs) in the first list. For instance, an example of a first list may be {event ID #m, action ID #n; . . . }, which indicates that action ID #n is allowed to be performed for network event ID #m. The embodiments are not limited to these lists, and the information may include any type of data structure that conveys the association of event(s) and the corresponding action(s).

The SMF 210 is further configured to generate a second list. The second list is indicative of a plurality of NF entities for notifying the UPF 220 of the plurality of network events. For instance, the second list may include information such as {a first event, a first source NF; a second event, a second source NF; . . . }. In a possible example, the events and the source NFs may be identified by respective IDs. The association of the IDs and actual events and source NFs may be pre-defined, for example, in 3GPP.

Then, the SMF 210 is configured to send the first list and the second list to the UPF 220. For instance, the first list and the second list may be combined and sent through a single signaling 201. Optionally, the first list and the second list may be sent before and/or during a session (including modifications to the lists). For instance, an example could be that the first list and second list are sent through an N4 session establishment/modification request message.

After receiving the first list and the second list, the UPF 220 is configured to send one or more subscription requests 202 for subscribing to one or more of the plurality of network events based on the first list and/or the second list.

Optionally, the UPF 220 may be configured to send a subscription request 202 to the SMF 210 for subscribing to a network event. When the SMF is not responsible for notifying the network event, the SMF 210 may be configured to forward the subscription request 202 to a target NF 230 (e.g., the NWDAF 230). Optionally, the SMF 210 may be configured to add or modify one or more parameters in the subscription request 202, and forward a modified subscription request 202′ to the target NF 230. Possible parameters that can be added or modified by the SMF 210 may include, but are not limited to: S-NSSAI, service area, UE ID, application ID, UE location, UE subscription INFO, etc. When a network event occurs, the UPF 220 may receive a notification message 203. The notification message 203 may come from the respective NF 230 or from the SMF 210. In the latter case, it is possible that the respective NF 230 sends the notification message 203 to the SMF 210, and the SMF 210 forwards the notification message 203 to the UPF 220.

It is noted that the UPF 220 may send a first subscription request for subscribing to a first network event to the SMF 210, and send a second subscription request for subscribing to a second network event to the target NF 230. This is not limited.

An example of the first list and the second list may be as follows in Table 1.

TABLE 1

| Event | Action |
|---|---|
| Event: Average/Minimum/Maximum | Action: FAR, QER and BAR rules according |
| Packet Delay Threshold exceeded [3GPP | to network operator policies. |
| TS 29.244] | |
| Source: UPF | |
| Event: Load control/overload control | Action: FAR rule to forward packets to a |
| (e.g., exceeded user capacity, resource | configured default PSA (via N9 or N6). Report |
| usage overload, etc.) [3GPP TS 29.244 | to SMF about capacity overload or buffer |
| clause 6.2.3, 6.2.4] | packets according to a BAR rule. SMF may |
| Source: UPF (via performance metrics | also configure preferential treatment to high |
| collected by UPF) | priority users and emergency services during |
| | overload conditions. |
| Event: Observed Service experience | Action: FAR rule to redirect traffic to different |
| statistics or predictions (e.g., application | instances of EAS or a different DN configured |
| status, application server overload) | by the local network operator policies. |
| Source: NWDAF via | |
| Nnwdaf_AnalyticsSubscription_Subscribe | |
| with Analytics ID: Service Experience | |
| Event: UE Abnormal Behaviour | Action: FAR rule to decrease MBR for the |
| exception report | QoS flow or stop forwarding UL/DL packets of |
| Source: NWDAF via | UE and wait for SMF to release the PDU |
| Nnwdaf_AnalyticsSubscription_Subscribe | session. |
| Analytics ID: Abnormal behaviour [3GPP | |
| TS 23.288 clause 6.7.5] | |
| Exceptions: Unexpected UE location, | |
| Ping-ponging across neighboring cells, | |
| Unexpected wakeup, Unexpected long- | |
| live/large rate flows, Suspicion of DDoS | |
| attack, etc. | |
| Event: Network performance info like | Action: FAR rule to reduce MBR of the QoS |
| statistics/predictions on load, on UEs in | flow or redirect to alternate DN. |
| the area | |
| Source: Nwdaf via | |
| Nnwdaf_AnalyticsSubscription_Subscribe | |
| Analytics ID: Network Performance | |
| Event: UE IDLE/CONNECTED, UE loss | Action: BAR rule to buffer the packet in UPF |
| of communication, UE reachability status | and the number of packets to buffer or forward |
| [3GPP TS 23.502] | the packets to SMF. |
| Source: AMF via | |
| Namf_EventExposure_Subscribe service | |
| Analytics ID: Connectivity state change, | |
| UE loss of communication, UE | |
| reachability status | |
| Event: QoS Sustainability | Action: FAR rule for modified MBR for the |
| Source: NWDAF via | QoS flow when thresholds are crossed or |
| Nnwdaf_AnalyticsSubscription_Subscribe | expected to cross. |
| Analytics ID: QOS Sustainability | |
| Event: PCC rule add/update for AF | Action: FAR rule to forward packets with the |
| influenced Traffic Steering Enforcement | application ID to new/alternate DN or EAS |
| [3GPP TS 23.501, clause 6.3.1] | requested by AF. |
| Source: PCF via | |
| Npcf_SMPolicyControl_UpdateNotify | |
| from SMF | |
| Event: traffic on DN crossed | |
| threshold/QoS not being met with current | |
| DN [3GPP TS 23.501, clause 6.3.1] | |
| Source: SMF | |

The “event” information in the first column and the “action” information in the second column in Table 1 may form the first list. The “source” in the first column in the Table 1 may form the second list. It is noted that Table 1 merely gives possible examples of network events, sources, and actions. It shall be understood that other network events, sources, and actions may also be included and any event, source, and action mentioned in the Table 1 may be modified or removed. Moreover, the actions in Table 1 are just given for illustration purposes only. It shall be understood that other possible actions may also be used to replace the actions defined in Table 1. Optionally, for a same network event, different actions may be determined by the CP entity 210.

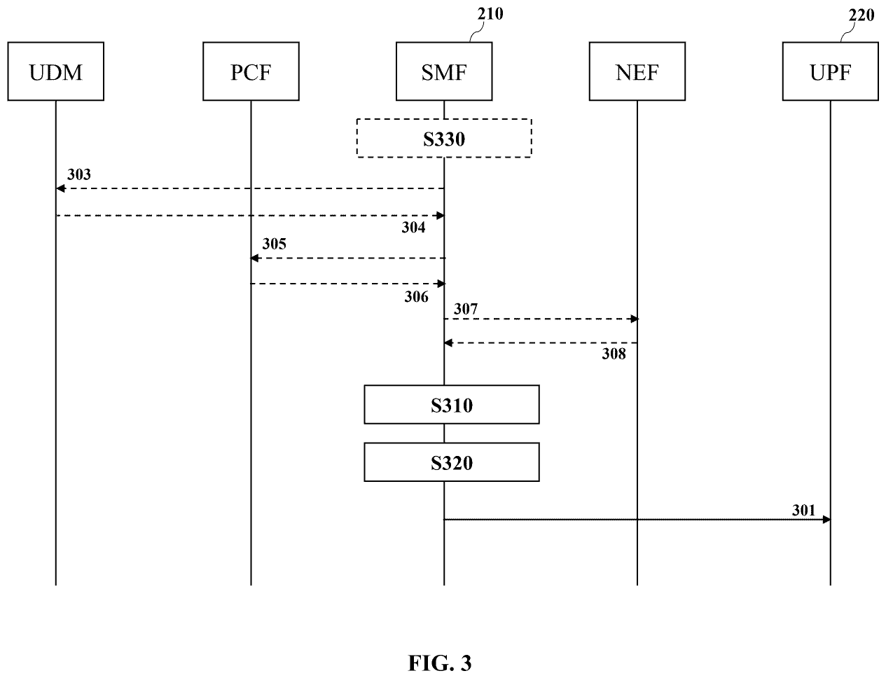

FIG. 3 shows an exemplary signaling flow for a CP entity notifying a first list and a second list to a UP entity according to the embodiments. FIG. 3 depicts an SMF that may correspond to the CP entity 210 in FIG. 2 and a UPF that may correspond to the UP entity 220 in FIG. 2. Corresponding elements may share the same features and function likewise.

As illustrated in FIG. 3, for generating the first list and the second list, the SMF may be configured to retrieve UE subscription information from a UDM. To this end, the SMF may send a UE subscription information request 303 to the UDM and receive a UE subscription information response 304 from the UDM.

The SMF may be further configured to retrieve QoS and policy-based information (e.g., PCC rules) from a PCF. To this end, the SMF may send a policy information request 305 to the PCF and receive a policy information response 306 from the PCF.

Based on the UE subscription information, policy information, and any other type of information obtained from the respective CP/MP entities configured by a network operator, the SMF may determine events that the UPF is allowed to respond to.

Optionally, the retrieval of the subscription information and the policy information may be triggered by event S330 when the UE sends a PDU session establishment/modification request, or when the SMF relocates a UPF for the UE.

Optionally, the SMF may query a NEF or a similar CP entity to identify a corresponding list of NFs that the UPF shall subscribe to in order to receive event notifications (or triggers) determined earlier. To this end, the SMF may send a request 307 to the NEF requesting information on NFs notifying network events, and configurations for subscriptions. In response, the SMF may receive corresponding information 308 from the NEF.

The SMF then may be configured to generate the first list in step or operation S310. Optionally, the SMF may be configured to create PDU session rules. Then, the SMF may be configured to generate the second list in step or operation S320. For instance, the SMF may be configured to create a list of CP NFs and instances associated therewith such that the UPF can subscribe to for receiving event triggers. The embodiments are not limited to the order in which the lists and the PDU session rules are generated and/or sent to the UP.

The SMF then is configured to send the first list and the second list to the UPF. Optionally, the first list and the second list may be sent via an N4 session establishment/modification request. Alternatively, the first list and the second list may be sent when the UPF is initiated/deployed in the telecommunications network or during a lifetime of a session. The CP NF (e.g., the SMF) may be configured to update the first list and/or the second list by sending an updated first list and/or an updated second list. The CP NF (e.g., the SMF) may be configured to remove the first list and/or the second list by sending corresponding instructions/configurations to the UP NF (e.g., the UPF) to delete (or deactivate) the first list and/or the second list.

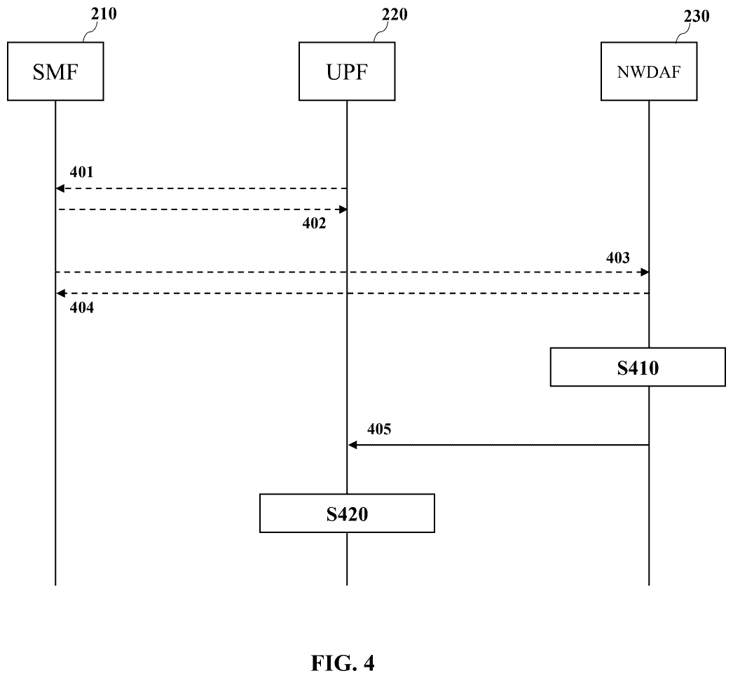

FIG. 4 shows an exemplary signaling for a UP entity subscribing to network events according to the embodiments. FIG. 4 depicts an SMF that may correspond to the CP entity 210 in FIG. 2, and a UPF that may correspond to the UP entity 220 in FIG. 2. Corresponding elements in FIGS. 1-4 may share the same features and function likewise.

Following FIG. 3, the UPF may be configured to store the first list for taking event-based actions. There are at least three possible ways for subscribing to network events.

In a first possible way, based on the received second list, the UPF creates one or more subscription requests. The UPF may send a subscription request directly to a target NF in accordance with the second list (not shown in FIG. 3).

In a second possible way, the UPF may send a subscription request 401 to the SMF. For instance, the subscription request 401 may be referred to as a “Nsmf_EventExposure_Subscribe_Request” message, which may include an event ID to be notified. Upon receiving the subscription request 401 from the UPF, the SMF may forward the subscription request 401 to the target NF, such as an NWDAF which publishes information for the event ID contained in the subscription request message. The SMF may acknowledge the request by replying via a so-called “Nsmf_EventExposure_Subscribe_Response” message 402 to the UPF. The forwarded subscription request 403 may be referred to as a “Nnwdaf_AnalyticsSubscription_Subscribe” message 403 comprising a notification target address (which may be equal to the UPF for example). Optionally, the SMF may be configured to add or modify one or more parameters (e.g., filter information) in the subscription request 401. The NWDAF may acknowledge the forwarded subscription request 403 by replying a “Nnwdaf_AnalyticsSubscription_Response” to the SMF.

In a third possible way, the SMF may create a subscription request (on behalf of the UPF). In this case, the UPF may not be required to send the subscription request 401 itself. The SMF may notify the UPF that a subscription request has been sent, e.g., through the “Nsmf_EventExposure_Subscribe_Response” message 402.

In step or operation S410, the CP NF like the NWDAF may monitor and/or analyze information to look for a subscribed event, and notify the UPF when the subscribed event is triggered (or found). For instance, the NWDAF may notify the UPF via a “Nnwdaf_AnalyticsSubscription_Notify” message 405. In step or operation S420, the UPF may be configured to analyze the triggered event, and perform corresponding actions if the triggered event is in accordance with the first list and the second list.

It is noted that the names of the messages 401, 402, 403, 404, and 405 in FIG. 4 are given for illustration purposes only. It shall be understood that other similar messages may also be used.

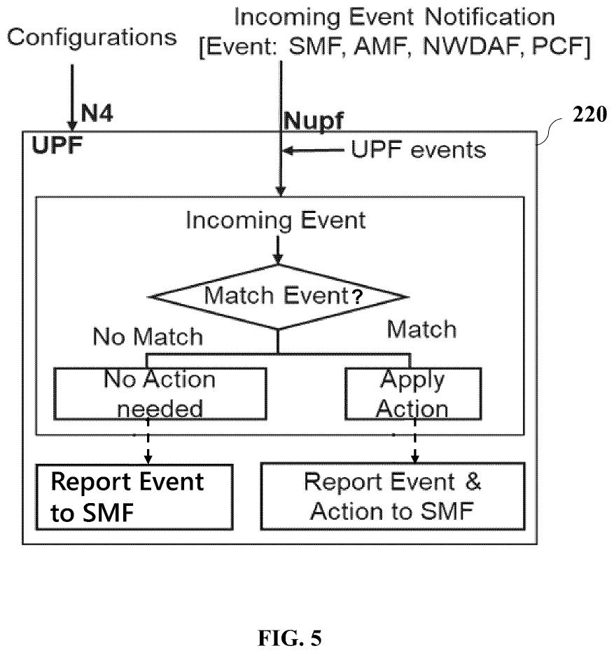

FIG. 5 shows an example of event processing performed by a UP entity according to the embodiments. The UP entity in FIG. 4 is based on the UP entity 220 in FIG. 2 and is exemplarily illustrated as a UPF 220. Corresponding elements in FIGS. 1-5 may share the same features and function likewise.

As depicted in FIG. 5, the UPF 220 may receive an event notification. The event notification may include a triggered event and a source. The source may be, e.g., SMF, AMF, NWDAF, PCF, etc. In a possible case, the UPF 220 may trigger an event internally, i.e., a UPF event. Once receiving or identifying an incoming event, the UPF 220 may be configured to try to match the incoming event with the plurality of network events on the first list. If the incoming event matches a network event on the first list, a corresponding action is applied in accordance with the first list. The corresponding action may include one or more steps or operations that the UPF 220 can perform in response to the incoming event. The UPF 220 may be further configured to report the incoming event and the action that has been taken to the SMF. Optionally, the UPF 220 may not immediately report the incoming event and the action. The UPF 220 may be configured to periodically report one or more incoming events and one or more actions taken during a pre-defined period of time. If the incoming event does not match any event on the first list, the UPF 220 does not take any action. Instead, the UPF 220 may report the incoming event to the SMF and wait for a decision from the control plane on how to respond to the event.

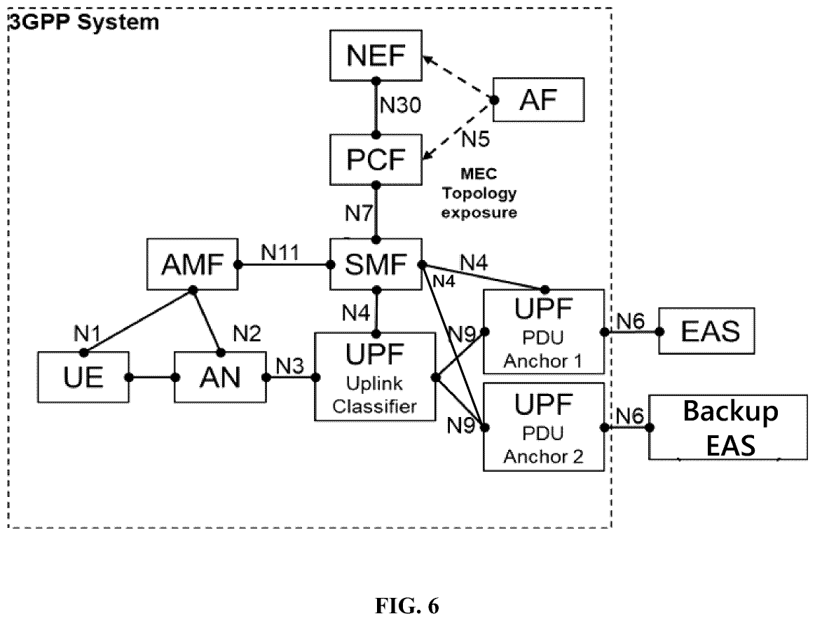

FIG. 6 shows an application scenario of the embodiments. In a telecommunications network, such as a 3GPP system, a UPF performs traffic classification and traffic redirection. For instance, the UPF decides whether traffic goes to a DN or to a nearest Edge Application Server (EAS). According to the embodiments, an SMF generates and sends the first list and the second list to the UPF. The UPF may subscribe to event triggers generated by CP NFs. As an example, the SMF may create an action for an event when a designated EAS goes down. For instance, the action may involve designating Data Network Access Identifier (DNAIs) that can be used as a backup for forwarding user traffic. That is, the first list may include an item like {event: a designated EAS goes down->action: change DNAI (e.g., associated with a backup EAS)}. Once a corresponding event trigger is received from a CP NF, e.g., from an AF via NEF or via PCF, indicating a current EAS went down, the UPF can timely take the corresponding action, e.g., switch to a different DNAI (e.g., associated with a backup EAS).

Optionally, the 3GPP system may include a number of UPFs. Though two UPFs are exemplarily depicted in FIG. 6, it is possible that hundreds of UPFs are deployed in the 3GPP system, in order to provide services to an enormous amount of connected devices. For instance, a type of UPF called an uplink (UL) classifier (CL) may be used to divert uplink traffic based on filter rules provided by the SMF. A further type of UPF called PDU Session Anchor (PSA) may be used to terminate the N6 interface of a PDU session within a core network.

By applying the embodiments, a UL CL UPF may be allowed to manage event subscriptions and event trigger distribution on behalf of a PSA UPF. In this way, signaling traffic arising due to UPF subscription and event notifications may be reduced in the core network.

FIG. 7 shows a diagram of a method 700 according to the embodiments. The method 700 is for a telecommunications network and includes the following steps or operations:
step or operation 701: generating, by a CP entity, a first list indicating a plurality of network events and a plurality of corresponding actions that a UP entity is allowed to perform;
step or operation 702: generating, by the CP entity, a second list indicating a plurality of NF entities for notifying the UP entity of the plurality of network events; and
step or operation 703: sending, by the CP entity, the first list and the second list to the UP entity.

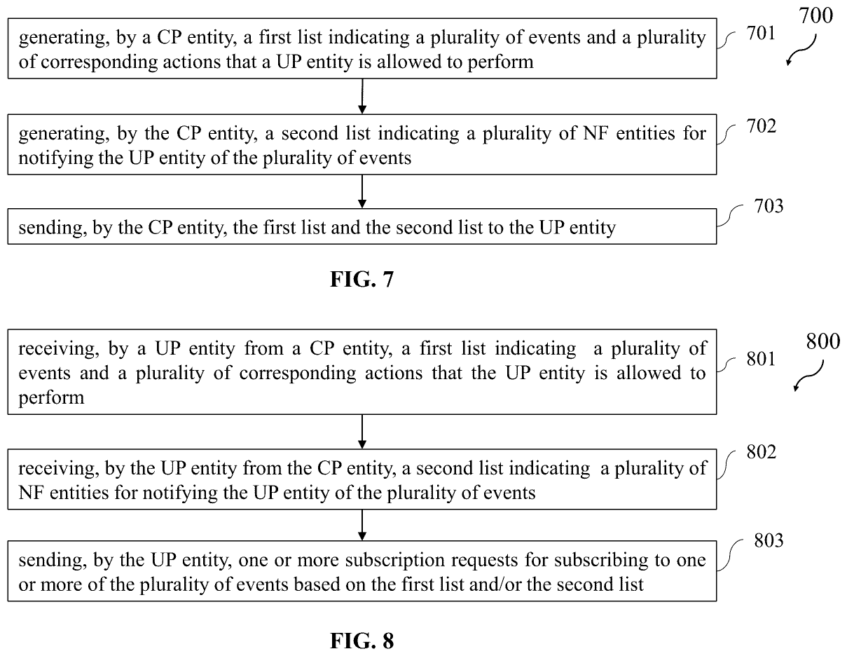

FIG. 8 shows a diagram of a further method 800 according to the embodiments.\

The method 800 is for a telecommunications network and includes the following steps or operations
step or operation 801: receiving, by a UP entity from a CP entity, a first list indicating a plurality of network events and a plurality of corresponding actions that the UP entity is allowed to perform;
step or operation 802: receiving, by the UP entity from the CP entity, a second list indicating a plurality of NF entities for notifying the UP entity of the plurality of network events; and
step or operation 803: sending, by the UP entity, one or more subscription requests for subscribing to one or more of the plurality of network events based on the first list and/or the second list.

It is noted that the steps or operations of methods 700 and 800 may share the same functions and details from the perspective of FIGS. 1-6 described above. Therefore, the corresponding method embodiments are not described in detail again at this point.

The embodiments may be applied to any telecommunications network, such as, but not limited to 5G, 5G-Advanced, 6G communications networks, and any other next generation mobile communications networks. Application scenarios of the embodiments include, but not limited to: Vehicle-to-Everything (V2X) networks, Internet-of-Things (IoT) networks, massive Machine-Type Communications (mMTC), etc.

In summary, the embodiments provide a solution for decoupling UP event processing and UP packet processing. This can be achieved through, e.g., pre-configuring the decisions/responses in UP NFs and notifying UP NFs of a triggered event directly from a CP NF. This can shorten processing paths for handling the triggered event. Further, the embodiments can enhance a CP NF (e.g., an SMF) and N4 interface to pass information regarding relevant NFs and events that a UP NF (e.g., a UPF) shall subscribe to for a PDU session during a PDU session establishment or modification process. Further, the embodiments can enhance a CP NF to forward a subscription request from a UP NF to a target CP NF to ensure security. The CP NF may add (or modify) any missing (or incorrect) parameters that are not available to the UP NF in the subscription request.

The embodiments can also proactively provide the UP NF with the capability to apply actions autonomously in case of triggered events. To this end, the CP NF may be enhanced to determine suitable events that the UP NF is allowed to react to, and to generate actions in advance on how the UP NF may react to the determined events. The N4 interface may be enhanced to provide the first list and the second list to the UP NF during a PDU session establishment or modification process. The UP NF may be enhanced to receive the first list and the second list, and to employ a Nupf interface to subscribe to the network events defined in accordance with the first list and/or the second list. The UP NF may autonomously apply a corresponding action upon receiving an event trigger via the Nupf interface.

The CP entity and the UP entity in this embodiment may include a processing circuitry or chipset (not shown) configured to respectively perform, conduct or initiate the various operations described herein. The processing circuitry may include hardware and software. The hardware may include analog circuitry or digital circuitry, or both analog and digital circuitry. The digital circuitry may include components such as application-specific integrated circuits (ASICs), field-programmable arrays (FPGAs), digital signal processors (DSPs), or multi-purpose processors. Optionally, the processing circuitry includes one or more processors and a non-transitory memory connected to the one or more processors. The non-transitory memory may carry executable program code which, when executed by the one or more processors, causes the devices to perform, conduct or initiate the operations or methods described herein.

Various embodiments have been described as examples. However, other variations may be understood and effected by those skilled in the art from the drawings and description herein. In the embodiments, the word “comprising” does not exclude other elements or steps or operations and the indefinite article “a” or “an” does not exclude a plurality. A single element or other unit may fulfill the functions of several entities or items described herein. The fact that certain measures are described separately does not indicate that a combination of these measures cannot be used in an advantageous embodiment.

1. A method comprising:
generating, by a control-plane (CP) entity, a first list indicating a plurality of events and a plurality of corresponding actions that a user-plane (UP) entity is allowed to perform;
generating, by the CP entity, a second list indicating a plurality of network function (NF) entities for notifying the UP entity of the plurality of events;
sending, by the CP entity, the first list and the second list to the UP entity.

2. The method according to claim 1,
wherein generating the first list comprises:
determining the plurality of events that the UP entity is allowed to be notified of based on network configuration information; and
generating the plurality of corresponding actions that the UP entity is allowed to perform for the determined plurality of events;
and wherein generating the second list comprises:
obtaining the list of NF entities for notifying the UP entity based on the determined plurality of events.

3. The method according to claim 1, wherein sending the first list and the second list to the UP entity comprises:
sending the first list and the second list to the UP entity via a dedicated interface or via an N4 interface.

4. The method according to claim 1, further comprising:
receiving one or more subscription requests from the UP entity for subscribing to one or more of the plurality of events; and
sending the one or more subscription requests to the one or more respective NF entities.

5. The method according to claim 4, wherein, before sending the one or more subscription requests, the method further comprises adding and/or modifying one or more parameters in the received one or more subscription requests.

6. The method according to claim 1, wherein sending the first list and the second list to the UP entity comprises:
sending the first list and the second list to the UP entity during a lifetime of a session, during a lifetime of a service delivery, or during a lifetime of the UP entity.

7. A method comprising:
receiving, by a user-plane (UP) entity from a control-plane (CP) entity, a first list indicating a plurality of events and a plurality of corresponding actions that the UP entity (220) is allowed to perform;
receiving, by the user-plane (UP) entity from the CP entity, a second list indicating a plurality of network function (NF) entities for notifying the UP entity of the plurality of events; and
sending, by the UP entity, one or more subscription requests for subscribing to one or more of the plurality of events based on the first list and/or the second list.

8. The method according to claim 7, further comprising: sending a respective subscription request to the CP entity.

9. The method according to claim 7, further comprising: sending a respective subscription request to a respective NF entity based on the second list.

10. The method according to claim 8, further comprising: receiving a notification from a respective NF entity or the CP entity of a triggered event.

11. The method according to claim 10, further comprising:
determining whether the triggered event is on the first list and/or whether the triggered event is originated from a corresponding NF entity on the second list; and
in response to determining that the triggered event is on the first list and/or the trigger event is originated from the corresponding NF on the second list, performing a corresponding action in accordance with the first list.

12. A system comprising:
one or more control-plane (CP) entities, and
one or more user-plane (UP) entities,
wherein:
the CP entity is configured to: generate a first list indicating a plurality of events and a plurality of corresponding actions that the UP entity is allowed to perform; generate a second list indicating a plurality of network function (NF) entities for notifying the UP entity of the plurality of events; and send the first list and the second list to the UP entity; and
the UP entity is configured to: receive, from the CP entity, the first list indicating the plurality of events and the plurality of corresponding actions that the UP entity is allowed to perform; receive, from the CP entity, the second list indicating the plurality of NF entities for notifying the UP entity of the plurality of events; and send one or more subscription requests for subscribing to one or more of the plurality of events based on the first list and/or the second list.

13. The system according to claim 12,
wherein the CP entity is further configured to: determine the plurality of events that the UP entity is allowed to be notified of based on network configuration information; and generate the plurality of corresponding actions that the UP entity is allowed to perform for the determined plurality of events; and obtain the list of NF entities for notifying the UP entity based on the determined plurality of events.

14. The system according to claim 12, wherein the CP entity is further configured to send the first list and the second list to the UP entity via a dedicated interface or via an N4 interface.

15. The system according to claim 12, wherein the CP entity is further configured to: receive one or more subscription requests from the UP entity for subscribing to one or more of the plurality of events; and send the one or more subscription requests to the one or more respective NF entities.

16. The system according to claim 15, wherein the CP entity is further configured to, before sending the one or more subscription requests, add and/or modify one or more parameters in the received one or more subscription requests.

17. The system according to claim 12, wherein the CP entity is further configured to send the first list and the second list to the UP entity during a lifetime of a session, during a lifetime of a service delivery, or during a lifetime of the UP entity.

18. The system according to claim 12, wherein the UP entity is further configured to send a respective subscription request to the CP entity.

19. The system according to claim 18, wherein the UP entity is further configured to send a respective subscription request to a respective NF entity based on the second list.

20. The system according to claim 18, wherein the UP entity is further configured to receive a notification from a respective NF entity or the CP entity of a triggered event.
